(19) United States
(12) Patent Application Publication
(10) Pub. No.: US 2017/0279277 A1
(43) Pub. Date: Sep. 28, 2017

(54) OPTIMIZATION METHOD OF THE CONSUMPTION OF POWER PRODUCED BY A RENEWABLE SOURCE

(71) Applicant: Schneider Electric Industries SAS, Rueil Malmaison (FR)

(72) Inventors: Teddy RUEZ, Grenoble (FR); Aurelien HAVEL, St Crepin-et-Carlucet (FR); Michel CLEMENCE, Chambery (FR)

(73) Assignee: Schneider Electric Industries SAS, Rueil Malmaison (FR)

(21) Appl. No.: 15/431,041

(22) Filed: Feb. 13, 2017

(30) Foreign Application Priority Data
Mar. 25, 2016 (FR) 16 52599

(51) Int. Cl. H02J 3/38; H02K 7/18; G05B 13/02; H02S 40/30

(52) U.S. Cl. CPC H02J 3/383; H02S 40/30; H02J 3/386; H02K 7/183; G05B 13/0255; H02J 2003/007

(57) ABSTRACT

A method for optimizing the consumption, by loads, of an electrical power produced by at least one renewable source and at least one non-intermittent source connected to an electricity production and distribution network, the method including a step of determining a time profile of a renewable power produced by the at least one renewable source; a step of determining, among loads connected to the network, constraints on the use of said loads; a step of determining a plan of operation of said loads for maximizing the consumption of the renewable power produced by the at least one renewable source, while respecting said constraints on use, this determination including an evaluation of the consumption of the renewable power under the effect of a time-shift in starting said loads.

### TECHNICAL FIELD

The field of the invention is that of electricity production and distribution microgrids. More particularly, the invention relates to a method for optimizing the consumption of electrical power produced by one or more renewable electricity sources.

### STATE OF THE PRIOR ART

A micro network or microgrid is generally a local electricity network intended to produce and distribute electrical energy in isolated regions, remote from large electrical energy production centres. Isolated regions are, for example, islands, mountainous regions, or desert areas. The microgrid principle also applies when a building, district, campus, or other entity connected to an extensive distribution network wishes to manage its energy production differently and increase its stability.

The main attraction of microgrids is that they can operate autonomously (in islanded mode, without a connection to the public network), and that they are located in the vicinity of the areas of consumption (the loads). Thus, the losses inherent in long distance distribution networks are limited.

The energy self-sufficiency of the microgrid is generally ensured by different types of electricity sources among which generator sets occupy an important place (this is known as a synchronous energy source). Indeed, from the economic point of view, a generator set represents a small initial investment, and ensures electricity production flexible enough to absorb consumption peaks at peak-load hours. However, their operation requires large quantities of fuel (e.g. diesel), which accordingly increases the energy bill, but also increases atmospheric pollution.

In order to mitigate these economic and environmental problems, microgrids are hybrid systems and also include renewable electricity sources such as photovoltaic electricity sources. The DC current and DC voltage generated by renewable electricity sources are generally transformed, by an inverter, into AC current and voltage at the frequency f of the network. The inverter is generally servo-controlled according to a control law conferring “droop” control in frequency/active power P and in effective voltage (RMS voltage)/reactive power Q. Droop control makes it possible to connect the inverter in parallel with synchronous generators (e.g. generator sets) on the electricity production and distribution network. However, the fluctuations and/or the intermittency of the production of electrical power from renewable electricity sources cause instability in the AC frequency, voltage and current delivered, via the inverter, by renewable electricity sources. The instability of the frequency of the voltage and current delivered by renewable electricity sources has direct repercussions on the generating plant and the distribution network. Generating plant is understood to mean all the renewable electricity sources, and all the non-renewable electricity sources connected to the distribution network and capable of producing electrical power. In order to limit the consequences and inconveniences caused by such instability, renewable electricity sources generally do not exceed 30% of the nominal power of said network (i.e. a penetration rate of renewable electricity sources limited to 30% of the nominal). The fluctuations in production of renewable electrical power are then offset by generator sets permanently in operation.

In order to increase the penetration rate of renewable electricity sources, the concept of a virtual generator or synchronous virtual generator has been developed, and the person skilled in the art will be able to consult document [1] describing in detail the basic principles of virtual generators. A virtual generator generally comprises a renewable electricity source, such as photovoltaic or wind turbine panels, and an inverter. The installation of virtual generators allows a penetration rate of renewable electricity sources of 100% to be achieved.

Although offering a considerable advance in terms of penetration rate and reducing fuel consumption, this solution does not address optimizing the consumption of power and/or electrical energy produced by renewable electricity sources.

Indeed, the aforementioned solutions do not allow generator sets to reduce fuel consumption when renewable energy production is halted (at night, for example, when photovoltaic electricity sources no longer produce electrical power).

Moreover, in order to ensure balance in the voltage and current frequency of the network, it may be desirable to limit the production of renewable electrical power, by peak-shaving. This peak-shaving is all the more desirable when the potential of installed renewable electrical power production reaches 100% of nominal power of the electricity production and distribution network. The peak-shaving of renewable electrical power production is generally undertaken by the inverter associated with said source and to the extent of its capabilities.

One objective of the present invention is then to provide a method for optimizing the consumption of power and/or electrical energy produced by a renewable electricity source so as to reduce fuel consumption by generator sets also connected to the electrical production and distribution network.

Another objective of the present invention is also to maximize the production of renewable electrical power by renewable electricity sources.

Another objective of the invention is also to optimize the renewable electrical power to be installed.

### DISCLOSURE OF THE INVENTION

The objects of the invention are, at least partly, achieved by a method for optimizing the consumption, by loads, of the power produced by at least one renewable electricity source and at least one non-intermittent electricity source connected to an electricity production and distribution network, the method comprising:

a. a step of forecasting a time profile of renewable electrical power produced by the at least one renewable electricity source for a coming time period;

b. a step of determining, among loads connected to the network, constraints on the use of said loads;

c. a step of determining a plan of operation of said loads for maximizing the consumption of the renewable electrical power produced by the at least one renewable electricity source, over the coming time period, while respecting said constraints on use, this determination including an evaluation of the consumption of the renewable electrical power under the effect of a time-shift in starting one or other of said loads.

Thus, consideration of the constraints on the use of said loads connected to the generating plant and to the distribution network makes it possible to adapt the modes of electrical power consumption, and to favour a consumption of electrical power as soon as the renewable electricity source produces electrical power. The consumption of renewable electrical power takes place in real time, and does not require any mode of storing power and/or energy for deferring such consumption. Indeed, according to the invention, it is now possible to at least partly time-shift the electrical power consumption phase of loads consuming, usually exclusively, the electrical power delivered by non-intermittent electricity sources.

Moreover, the invention makes it possible to consider a “pre-consumption” of electrical power by loads as soon as the renewable electricity source produces electrical power so as to raise the energy state of said loads. Raising the energy state of said loads thus allows a lesser consumption of electrical power as soon as the renewable electricity source ceases its production of electrical power.

The invention thus makes it possible to reduce the consumption of power produced by the non-intermittent electricity source.

According to one embodiment, step c. of determining a load operation plan is also suitable for minimizing the consumption, by the loads, of the electrical power produced by the at least one non-intermittent electricity source.

Thus, reducing the capacity for electrical power production by the non-intermittent electricity source may also be envisaged.

According to one embodiment, step c. of determining the load operation plan is performed by a mathematical algorithm modelling the renewable electrical power produced by the at least one renewable electricity source, the consumption of electrical power by the loads according to the constraints on their use, the mathematical algorithm being advantageously a Branch and Bound and Cutting Plane algorithm.

The mathematical problem may, advantageously, be formulated according to the techniques of Mixed-Integer Linear Programming.

According to one embodiment, the at least one renewable electricity source offers an electrical power production capacity dimensioned so that a maximum of loads, among the loads connected to the network, consumes electrical power produced by said renewable electricity source.

The electrical power produced by the at least one renewable electricity source is advantageously consumed in real time. In other words, no system of storing power and/or energy is necessary for deferring said consumption.

According to one embodiment, the renewable electricity source includes at least one of the sources selected from: a photovoltaic electricity source and a wind turbine electricity source.

According to one embodiment, the renewable electricity source comprises a renewable electricity production system, and an inverter intended to transform the power produced by said production system into an AC voltage and current, the inverter and the production system being controlled by a control law so that the renewable electricity source forms a virtual generator.

According to one embodiment, the electrical production and distribution network has a nominal power, and the at least one renewable electricity source has an electrical power production capacity greater than said nominal power.

According to one embodiment, the electrical production and distribution network is a microgrid.

According to one embodiment, generator sets are also connected to the electrical production and distribution network, and in parallel with the renewable electricity source.

### BRIEF DESCRIPTION OF THE DRAWINGS

Other features and advantages will appear in the following description of the implementations of a method for optimizing the consumption, by loads, of the power produced by at least one renewable electricity source and at least one non-intermittent energy source, given as non-restrictive examples, with reference to the accompanying drawings in which:

FIG. 1 is a simplified diagram of the steps in a method according to the invention;

FIG. 2 is a graph representing the nominal power, Pₙₒₘ, of a microgrid, the electrical power (curve A) produced and delivered by a renewable electricity source to the microgrid, and the electrical power (curve B) consumed by loads connected to the microgrid, the curves being represented as a function of time t (on the horizontal axis);

FIG. 3 is a graph representing the implementation of an optimization method according to the invention, the graph representing the nominal power, Pₙₒₘ, of a microgrid, the electrical power (curve A) produced and delivered by a renewable electricity source to the microgrid, and the electrical power (curve B) consumed by loads connected to the microgrid, the curves being represented as a function of time t (on the horizontal axis).

### DETAILED DISCLOSURE OF PARTICULAR EMBODIMENTS

The present invention will now be described in the context of microgrids, but may very well extend to any type of electricity production and distribution network. Thus, unless stated otherwise, the term “microgrid” may refer to both microgrid and network.

In the present invention, loads will be considered that are capable of consuming power and/or electrical energy produced by (renewable or non-renewable) electricity sources. It is understood that when loads consume electrical power over a time range, said loads consume electrical energy. However, the disclosure of the invention will be limited to the production and consumption of electrical power, it being understood that, when said production and/or consumption take place over time it will involve production and/or consumption of electrical energy.

A microgrid will therefore be considered including at least one renewable electricity source.

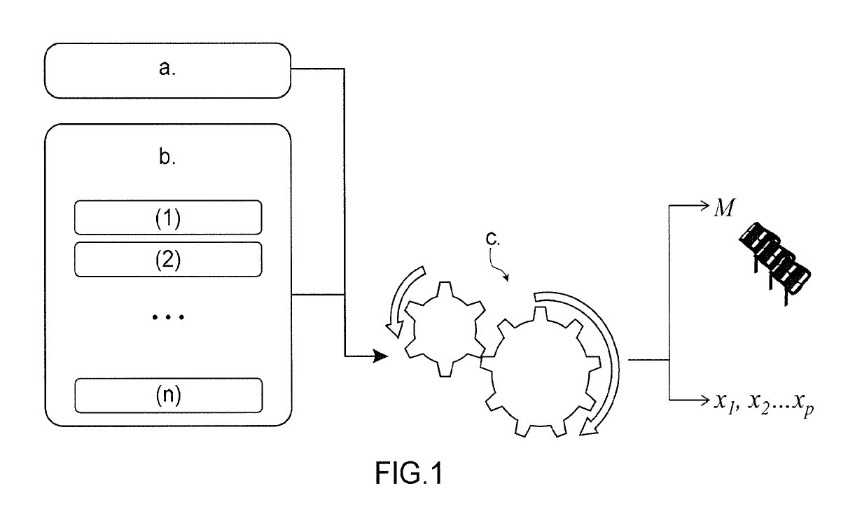

With reference to FIG. 1, a description will therefore be given of a method for optimizing the consumption of electrical power produced by at least one renewable electricity source.

The microgrid according to the invention thus comprises:
at least one renewable electricity source delivering a renewable electrical power to the microgrid,
at least one load or a plurality of loads, intended to consume electrical power delivered to the microgrid.

The microgrid may also include non-intermittent electricity sources such as generator sets. Non-intermittent electricity sources consume a fuel for producing and delivering electrical power to the microgrid.

Load refers to an element which is connected to the network and which consumes the electrical power present on said network (the electrical power, as previously stated, is consumed over a time range, and may therefore be associated with a consumed energy).

The optimization method comprises a step a. of forecasting a time profile of electrical power production by the renewable electricity source for a coming time period.

The coming time period may cover, for example, a cycle of one day, or several days.

The forecast of the power production time profile may occur from one day to the next, but may also correspond to longer term forecasts, e.g. a week, or a month.

Renewable electricity sources are often described as intermittent electricity sources since they are very dependent on non-controllable factors such as climatic conditions.

Thus, one or more renewable electricity sources may include one or more photovoltaic electricity sources, and/or one or more wind turbine electricity sources. Photovoltaic electricity sources produce electrical power only in the presence of sunshine. Moreover, the time profile of electrical power produced by photovoltaic electricity sources depends on climatic conditions, as well as on the orientation of said sources with respect to the sun. Indeed, fully south-facing photovoltaic panels do not present the same time profile of produced electrical power as east- or west-facing photovoltaic panels. Moreover, photovoltaic panels may present a variable orientation with respect to the sun (i.e. they “follow the sun”) so as to maximize the electrical power that they produce.

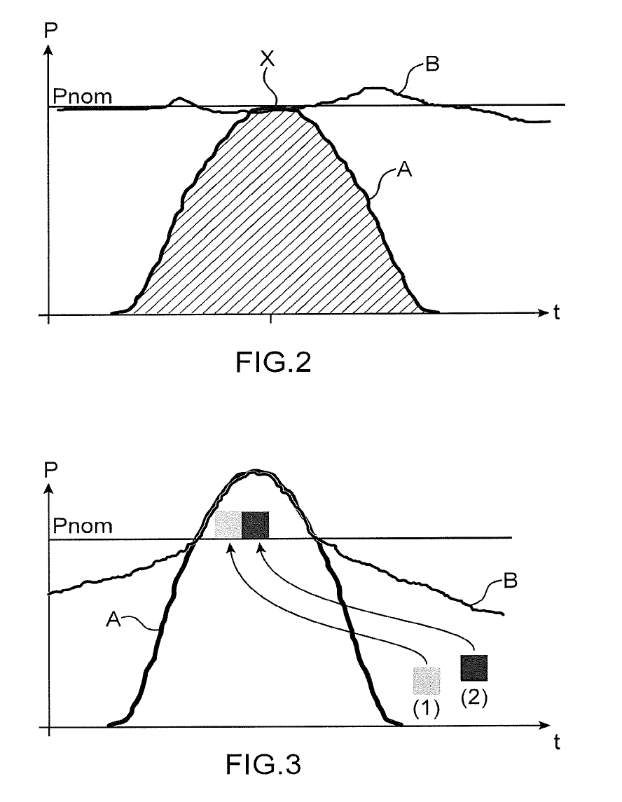

By way of example, FIG. 2 presents the electrical power production profile (P along the ordinate axis) of a photovoltaic electricity source (curve A) in the course of a day (time t along the abscissa axis). In the case illustrated in FIG. 2, the photovoltaic electricity source is fully south-facing so that the profile presents a bell shape and a maximum of electrical power production is observed at noon (point X on curve A). The level Pₙₒₘ is the nominal power of the microgrid, that is to say, the average electrical power consumed by the loads connected to the microgrid.

More “flattened” profiles (not represented) may be observed for other orientations of photovoltaic electricity sources.

Wind turbine electricity sources are also dependent on climatic conditions. Indeed, wind turbines only produce electrical power for winds blowing in a predetermined range of speeds.

The time profile of renewable electrical power production will therefore depend on the type of renewable electricity source.

Determining or predicting the time profile of renewable electrical power production may be based on a predictive model. Indeed, knowledge of the factors influencing the production of renewable electrical power by a given type of renewable electricity source may be used to predict the profile of electrical power production by said source.

Thus, knowledge of weather conditions and the specifications of photovoltaic electricity sources can be used to predict the time profile of electrical power production by photovoltaic electricity sources.

Determining or predicting the time profile of renewable electrical power production may also be based on the production history of renewable electrical power. Indeed, the daily monitoring of the production of renewable electrical power may be used to anticipate the renewable electrical power that will be produced in the future. This type of determination will be particularly advantageous when the non-controllable factors influencing the production of renewable electrical power are reproducible over time. Thus, in regions with stable and reproducible sunshine, it is possible to predict the renewable electrical power produced by photovoltaic electricity sources over time scales, e.g. of the order of a year. This model may be refined by taking weather forecasts into account.

The method according to the invention also includes a step b. of determining, among loads connected to the network, constraints on the use of said loads. Loads are represented by the integers between parentheses (1), (2), . . . , (n) in frame b. of FIG. 1.

Loads may also present constraints on starting which may be taken into account in the performance of step b.

A constraint on starting of a load is understood to refer to the starting modalities of said load for allowing its use according to predetermined specifications. In other words, a constraint on starting of a given load corresponds to the time and the power needed by said load to reach a given energy state. Starting said load includes the consumption of electrical power. Symmetrically suppressing a load must respect certain constraints.

Constraint on use is understood to refer to the service rendered by a given load. In other words, a constraint on use corresponds to a range of states or one state, advantageously a range of energy states or one energy state, in which the load must be situated in order to be usable according to its operating specifications. Operating specifications are defined as a setpoint to be achieved by a physical parameter of said load. In other words, the operating specifications are the set of requirements to be met by the load in order to be usable. Said load state is achieved by electrical power consumption. The range of states may be a range of energy states, but may also be associated with a stock. For example, the constraint on use may be a range of temperatures that the water of a water heater must reach in order to be usable. In the case of heating or air conditioning of a closed environment, the constraint on use may be the temperature range in which the temperature of said environment must be situated. In the case of a factory having a stock, the constraint on use will be the minimum stock that the factory must have at different time intervals, and the maximum stock that the factory has and which may under no circumstance be exceeded (the stock may correspond to a quantity of product manufactured in a factory). In the case of a water tower, the constraint on use corresponds to the minimum quantity of water that the water tower must have at different time intervals and the maximum quantity of water physically constrained by said water tower.

As previously mentioned, the loads connected to the microgrid, consume over a given time period, electrical power produced by the renewable electricity source or sources, and the non-intermittent electricity sources such as generator sets.

Loads connected to the microgrid are subject to constraints on starting and use.

For example, the case may be cited of a water heater that must be capable of delivering hot water in a range of given temperatures, and over a given hourly range. In general, water heaters are programmed to heat water at night, so that, in the morning, the temperature of the water is within a given temperature range, e.g. between 60 and 80° C. According to this operating mode known to the prior art, water heaters consume electrical power produced by non-intermittent electricity sources (generator sets).

In the context of the present invention, it is thus proposed to examine the effect of a time-shift in starting the load, water heaters in this example, at the moment when renewable electricity sources produce renewable electrical power.

The time-shift in starting a given load may consist of a pre-consumption of electrical power in such a way as to bring said load into a range of states or one given state (e.g. a range of energy states or one energy state) during the phase of renewable electrical power production by the renewable electricity source. This pre-consumption allows the consumption of electrical power by said load to be reduced when the renewable electricity source no longer produces electrical power. Thus, in the example of the water heater, a start-up as soon as the production of renewable electrical power is appreciable, will allow less consumption of non-intermittent power delivered by generator sets for maintaining the temperature of the hot water in the water heater in the predetermined temperature range.

This analysis may be performed for each of the loads connected to the microgrid.

Table 1 below provides other examples of loads and associated constraints on starting and use.

TABLE 1

| | Constraints on starting and use at each |
|---|---|
| Load | instant |
| Water heater | Ensuring continuity of service, and |
| | maintaining the water temperature within a |
| | given temperature range |
| Cold storage | Inside temperature maintained within a |
| | given temperature range |
| Drinking water/water tower | Ensuring a sufficient volume of water for |
| | ensuring needs |
| Heating, ventilation and air | Maintaining the temperature in a comfort |
| conditioning system | zone |
| Battery | Maintaining a minimum charge level |

Step b. of the method according to the invention therefore includes the determination of constraints on the use of the loads connected to the microgrid. This analysis, although more detailed in the context of water heaters, is not limited only to water heaters, and thus applies to any type of loads. The analysis can be used to report on the flexibility of operation and use of the loads considered.

Flexibility of operation and use refers to the possibility of time-shifting the starting of a load without, however, affecting the fulfilment of its constraint on use. The time-shift in starting a load corresponds to a total or partial shift of the electrical power consumption by said load.

Flexibility of operation and use also refers to the downward or upward variation in consumption of electrical power by continuous loads. Continuous loads are understood to mean loads permanently consuming electrical power in normal conditions of use and according to a known operation of the prior art.

The method according to the invention also includes a step c. of determining a load operation plan for maximizing the consumption of the electrical power produced by the at least one renewable electricity source, over the coming time period, while respecting said constraints on use, this determination including an evaluation of the consumption under the effect of a time-shift in starting one or other of said loads or a modulation of electrical power supplied to the load.

Load operation plan refers to the electrical power consumed during time ranges, (e.g. intervals of 30 minutes, 10 minutes, etc.) by said loads. The operation plan is thus defined for each of the loads connected to the microgrid, and includes, for each load, one or more operating time ranges as well as the electrical power consumed by said load. The operation plan thus establishes, for all the loads connected to the network, the starting modalities of each of said loads, the starting modalities including the operating time ranges and the electrical power consumed during said time ranges.

The performance of this step c. comprises the selection of loads, from among the loads connected to the network, whereof the constraints on starting and use allow a time-shift in starting. The time-shift is adjusted so that the loads consume electrical power as soon as the renewable electricity source produces and delivers electrical power on the microgrid.

The loads selected for being started, as soon as the renewable electricity source produces and delivers electrical power on the microgrid, may also consume electrical power when the renewable electricity source neither produces nor delivers electrical power on the microgrid. In this case, the electrical power is delivered by the non-intermittent energy source. This time distribution in terms of electrical power consumption on the part of the selected loads can be used to increase the consumption of renewable electrical power and reduce the consumption of electrical power delivered by the non-intermittent electricity source. It is thus possible to reduce the amount of fuel necessary for the proper operation of the microgrid.

In a particularly advantageous way, step c. may be performed with the aid of a mathematical algorithm. The time profile of renewable energy production from the renewable electricity source as well as the constraints on starting and use of the loads connected to the microgrid constitute input data for said mathematical model.

The mathematical model is thus suitable for modelling the operation of the microgrid according to the input data.

The mathematical model includes an objective function, constraints, decision variables and parameters.

The mathematical model includes the minimization of an objective function under constraints.

According to the invention, the objective function may represent an operating “cost” of the microgrid. The operating “cost” of the microgrid is, for example, associated with a fuel consumption by the non-intermittent electricity sources, but may also take into account (and in a non-restrictive way):
user satisfaction for the various loads;
maximization of the consumption of renewable electrical power consumed by the loads;
maximization of the production of renewable electrical power.

The constraints include the operating constraints and, optionally, the constraints on starting the loads. Among said loads the loads for which starting cannot be shifted are also identified. These loads, for which starting cannot be shifted, are described as non-flexible loads, while other loads are flexible loads. The power consumption demand of non-flexible loads is described as unavoidable demand.

In order to ensure the stability of the microgrid, a constraint of energy reserve relative to the non-intermittent means of production may be considered. Non-linear constraints e.g. the temperature change in a cold room may be linearized.

The mathematical model and the constraints are based on a number of input parameters:
the electrical power production profiles of the renewable electricity sources and non-intermittent electricity sources (these profiles are assumed to be known),
the operating costs of the various loads and means of production,
the operating parameters of the various loads and means of production.

The object of the minimization problem is to find the optimum values of the set of decision variables. These decision variables are specific to each load which may then be of different natures according to the load (time, power).

For example, the time ranges (operating hours) and operating powers of the flexible loads (reflecting the constraints on starting and use of said loads), as well as the various non-intermittent means of electrical power production are decision variables of the problem. These variables may be integers or real numbers.

The problem thus formulated with the objective function and its constraints is similar to the “Knapsack Problem” well known to the person skilled in the art and described in document [2].

The solution of such a problem may advantageously be achieved by an algorithm combining “Branch & Bound” and “Cutting Plane” techniques, described in document [2].

The solution of the problem by mathematical algorithm allows a better optimization of the consumption of the electrical power consumed by the loads connected to the microgrid.

The steps in modelling and/or solving the mathematical algorithm may advantageously be performed by a calculator or a computer.

Optimization may be performed statically or dynamically, then periodically taking into account the renewable energy production forecasts and establishing an adaptive production/consumption plan (or schedule).

Static optimization may be preferred when the production of renewable electrical power is of a reproducible nature. For example, the case of photovoltaic electricity sources connected to a microgrid in a region strongly sunlit throughout the year may be suited to static optimization.

Dynamic optimization, more efficient for optimizing the share of electrical power produced by said renewable electricity sources, involves putting in place communicating devices for monitoring flexibilities, unlike the static optimum where flexibilities may be set definitively.

On the other hand, the presence of wind turbine electricity sources in the microgrid may force dynamic optimization in step c.

Thus, the output data of step c. include:
selecting loads that can be started up during the renewable electrical power production phase by the renewable electricity source (the data x₁, x₂, . . . , xₙ in FIG. 1);
the renewable electrical power consumable by the selected loads.

In a particularly advantageous way, step c. of optimization may also allow the dimensioning of the renewable electricity source, that is to say, the renewable electrical power production capacity.

Thus, the method according to the invention, can also be used to install a renewable electrical power potential greater than the nominal power of the microgrid.

The optimization method according to the invention may result in a time-shift in starting loads so that said loads consume an electrical power greater than the nominal power of the microgrid. The optimization method according to the invention will therefore lead to the installation of a renewable electrical power production capacity greater than the nominal power of the microgrid. Thus, the time-shift in starting loads allows having a penetration rate of renewable energies greater than 100%.

In this case, the renewable electricity source or sources may advantageously be configured as virtual generators.

In this regard, a virtual generator means a virtual generator behaving like a generator set.

To do this, the renewable electricity source may include a renewable electricity production system, and an inverter. The inverter is intended to transform the power produced by said production system into an AC voltage and current. The inverter and the renewable electricity production system may be controlled by a control law so that the renewable electricity source behaves as a virtual generator.

By way of illustration, FIG. 3 is a schematic representation of the implementation of the method according to the invention. The abscissa axis represents the time t, and the ordinate axis represents the electrical power P. The horizontal line Pₙₒₘ represents the nominal power of the microgrid. Curve A represents the renewable electrical power produced by a renewable electricity source (e.g. a photovoltaic energy source), and curve B the electrical power consumed by the loads. In this example, the renewable electrical power exceeds the nominal power of the microgrid. Loads (loads (1) and (2) in grey and black respectively) are “displaced”. According to known methods of the prior art, for reasons of constraints on starting and use, loads (1) and (2) consume electrical power outside of periods of renewable electrical power production (e.g. water heaters). However, the optimization method according to the invention allows for considering a preheating of said water heaters as soon as the renewable electricity source produces and delivers power on the microgrid.

The method according to the invention can therefore be used to optimize the consumption of renewable electrical power produced by renewable electricity sources, and to minimize peak-shaving. Moreover, the penetration rate of renewable energies may also exceed the nominal power of the network, and thus allow having less recourse to non-intermittent electricity sources. The result is therefore a reduction in fuel consumption.

### REFERENCES

[1] Hussam Alatrash et. al., “Generator Emulation Controls for Photovoltaic Inverters”, IEEE TRANSACTIONS ON SMART GRID, Vol. 3, No. 2, June 2012.
[2] Garfinkel, Robert S., and George L. Nemhauser. Integer programming. Vol. 4. New York: Wiley, 1972.).

1. A method for optimizing consumption, by loads, of an electrical power produced by at least one renewable electricity source and at least one non-intermittent electricity source connected to an electricity production and distribution network, the method comprising:
a) a step of forecasting a time profile of a renewable electrical power produced by the at least one renewable electricity source for a coming time period;
b) a step of determining, among loads connected to the network, constraints on the use of said loads;
c) a step of determining a plan of operation of said loads for maximizing the consumption of the renewable electrical power produced by the at least one renewable electricity source, over the coming time period, while respecting said constraints on use, said determining including an evaluation of the consumption of the renewable electrical power under the effect of a time-shift in starting one or other of said loads.

2. The method according to claim 1, in which step c) of determining a load operation plan is also suitable for minimizing the consumption, by the loads, of electrical power produced by the at least one non-intermittent electricity source.

3. The method according to claim 1, in which step c) of determining the load operation plan is performed by a mathematical algorithm modelling the renewable electrical power produced by the at least one renewable electricity source, the consumption of electrical power by the loads according to the constraints on their use, the mathematical algorithm being advantageously solved by a combination of a Branch and Bound algorithm and Cutting Plane techniques.

4. The method according to claim 1, in which the at least one renewable electricity source offers a renewable electrical power production capacity dimensioned so that a maximum of loads, among the loads connected to the network, consumes the renewable electrical power produced by said at least one renewable electricity source.

5. The method according to claim 1, in which the at least one renewable electricity source includes at least one source selected from a photovoltaic electricity source and a wind turbine electricity source.

6. The method according to claim 1, in which the at least one renewable electricity source comprises a renewable electricity production system, an inverter intended to transform an electrical power produced by said production system into an AC voltage and current, the inverter and the renewable electricity production system being controlled by a control law so that the renewable electricity source forms a virtual generator.

7. The method according to claim 1, in which the electrical production and distribution network has a nominal power, and the at least one renewable electricity source has an electrical power production capacity greater than said nominal power.

8. The method according to claim 1, in which the electrical production and distribution network is a microgrid.

9. The method according to claim 1, in which generator sets are also connected to the electrical production and distribution network, and in parallel with the at least one renewable electricity source.
